(19) United States
(12) Patent Application Publication
(10) Pub. No.: US 2008/0071009 A1
(43) Pub. Date: Mar. 20, 2008

(54) Polystyrene Containing Masterbatch Composition For Poleyster Modification

(76) Inventor: Dirk Simon, Lorrach-Brombach (DE)

Correspondence Address: JoAnn Villamizar;Ciba Corporation/Patent Department, 540 White Plains Road, P.O. Box 2005, Tarrytown, NY, 10591, US

(21) Appl. No.: 11/628,697

(22) PCT Filed: Jun. 8, 2005
(86) PCT No.: PCT/EP05/52623

§ 371 Date: Dec. 6, 2006

(30) Foreign Application Priority Data
Jun. 17, 2004 (EP) 04102776.4

(51) Int. Cl. C08K 5/53; C08J 3/22; C08L 25/06; C08L 67/02

(52) U.S. Cl. 523/351; 524/130; 524/131

(57) ABSTRACT

The present invention relates to masterbatches useful for modifying thermoplastic polyesters, in particular to masterbatches comprising dispersed chain coupling agents, such as for example dianhydrides and optionally a polyol branching agent. The invention also relates to a method for preparing the masterbatches, and to a method for modifying a polyester utilizing the masterbatches. Yet another aspect of the invention is the use of such a masterbatch composition for the modification of polyesters.

The present invention relates to masterbatches useful for modifying thermoplastic polyesters, in particular to masterbatches comprising dispersed chain coupling agents and polyol branching agents. The invention also relates to a method for preparing the masterbatches, and to a method for modifying a polyester utilizing the masterbatches.

Thermoplastic polyesters such as poly(ethylene terephthalate) (PET) and poly(butylene terephthalate) (PBT) are widely used in the fields of extrusion, injection molding and stretch blow molding to produce products such as fibers, containers and films.

While polyesters may be used in other fields such as film blowing, tentering, thermoforming and foam extrusion, their use in these fields is often limited by the need for a narrow processing window and spezialised processing equipment. Such limitations generally stem from deficiencies in the melt rheology of the polyesters. In particular, polyesters typically have low melt viscosity, low melt strength and low melt elasticity.

It is known that the melt strength and melt viscosity of polyesters can be improved through the introduction of a degree of branching in the linear chain structure of the polymer, and/or by increasing the polymers molecular weight through chain extension. One approach used to prepare branched or chain extended polyesters has involved melt mixing polyesters with branching and/or chain coupling agents such as polyfunctional carboxylic acids, anhydrides or alcohols. During melt mixing, the agents react with the molten polyester to chain extend and/or introduce branching in the linear chain structure of the polymer.

Depending upon the type of branching/chain coupling agent(s) used to modify the polyester, the overall effect of the melt mixing reaction may in fact decrease the molecular weight of the polyester. This will often be the case where the only type of agent used is a polyol branching agent. Under these circumstances, in order to achieve the desired increase in melt strength and melt viscosity, a chain coupling agent can be used in combination with the polyol, or the resulting branched polyester can be subjected to a further processing step such as a solid state condensation process. In contrast, polyanhydride branching/chain coupling agents can introduce branching, but also generally cause an increase in the molecular weight of the polymer during melt mixing. Accordingly, polyanhydride branching/chain coupling agents can be used as a sole branching/chain coupling agent without subjecting the modified polyester to further processing.

Regardless of the type of branching/chain coupling agent used, to effectively modify the polyester it is important that the degree of branching/chain coupling can be controlled during the melt mixing process, and that branching/chain coupling occurs uniformly in the polyester.

Generally melt mixing is performed in an extruder, and the branching/chain coupling agent can be added to the polyester either before extrusion, or to the molten polyester during extrusion. The most simplistic way in which the agent can be added to the polyester is by direct addition. However, this mode of addition has been found to lead to gel formation through excessive localized chain coupling, and non-uniform branching within the modified polyester. This also leads to detrimental discoloration. Furthermore, it is not uncommon to use amounts of less than 0.5 weight percent of the branching/chain coupling agent, relative to the polyester to be modified. At these low levels, it is difficult to provide a uniform distribution of the agent in the polyester by direct addition.

Many of the aforementioned problems associated with the addition of branching/chain coupling agents can be overcome through use of a polymer blend, concentrate, or masterbatch as it is commonly referred to in the art. The masterbatch comprises high levels of the branching/chain coupling agent, but when added to the polyester it in effect acts as a diluted source of the agent. This diluent effect enables the branching/chain coupling agent to be distributed more evenly throughout the polyester and promotes a more uniformly branched/chain extended polyester.

In its simplest form, the masterbatch may be a physical blend of a carrier polymer and the branching/chain coupling agent, with both the agent and the carrier polymer often being in a powdered form. To avoid problems associated with incompatibility, the carrier polymer may be the same as, or of the same general class as, the base polymer to which the masterbatch is to be melt mixed with. For example, if the base polymer is a polyester, the carrier polymer may also be a polyester. Although effective, such physical blends do have a tendency to separate out into the individual components and again give rise to non-uniform distribution of the branching/chain coupling agent.

A masterbatch can also be readily formed by melt mixing a carrier polymer with the branching/chain coupling agent. However, when the carrier is a polyester this may lead to problems. In particular, given that the branching/chain coupling agents react with a polyester during melt mixing, the same or similar carrier polyester may also generally react with the agents during preparation of the masterbatch.

It would therefore be desirable to provide a masterbatch that comprised a thermoplastic polymer as a carrier material and a branching and/or a coupling agent, wherein the carrier polymer and the branching and/or a coupling agent can not react with each other and the carrier resin is highly compatible with polyester resins. Furthermore the masterbatch would be less restricted in terms of the amount and type of the branching and/or coupling agent incorporated.

Surprisingly, it has been found that styrene homo and copolymers can be melt mixed with branching and chain coupling agents without significant reaction occurring between the branching and chain coupling agent and the styrene homo and copolymers. Under these circumstances, styrene homo and copolymers can be melt mixed with a wide array of branching and chain coupling agents at both high and low concentrations to prepare masterbatches useful for subsequent melt mixing with thermoplastic polyesters. Advantageously, agents such as polyfunctional acid anhydrides, polyols and phosphorous containing compounds can be combined together within the masterbatch of the present invention.

One aspect of the present invention is a masterbatch composition for the modification of polyesters or copolyesters comprising a chain coupling agent capable of reacting with the polyester or copolyester, which is dispersed within a polymeric matrix of a styrene containing homopolymer or copolymer. (Anspruch 1)

In a specific embodiment the masterbatch composition comprises additionally a chain branching agent. (Anspruch 2)

As used herein, the term “masterbatch” has the common meaning as would be understood by one skilled in the art. With particular reference to the present invention, a masterbatch is a composition comprising a styrene containing homopolymer or copolymer as a carrier polymer and an agent, such as a branching and a chain coupling agent, where the concentration of the agent is higher than desired in a final product, and which composition is subsequently let down in a base polymer to produce the final product having the desired amount of agent. As used herein, the term “melting temperature” of a branching or chain coupling agent is used to denote a temperature at which the agent begins to melt.

As used herein, the term “melt processing temperature” of a carrier polymer like styrene homo- or co-polymers or polyesters is used to denote the lowest temperature that the polymer can be maintained at to enable it to be effectively melt processed.

As used herein, the term “branching agent” or “branching compound” is used to denote a polyfunctional compound which can react with a polyester to introduce branching therein. It will be appreciated that in order to introduce branching, the branching agent will necessarily have at least three functional groups that are capable of reacting with the polyester.

As used herein, the phrase “a chain coupling and a branching agent” is used to mean at least one chain branching agent and chain coupling agent. It embraces both types of agent and multiple agents in combination.

The branching and chain coupling agent in accordance with the masterbatch of the present invention is dispersed within a polymeric matrix of a styrene containing homopolymer or copolymer. By “dispersed” is meant that the agent is present as a separate unreacted entity within the polymeric matrix, and has therefore not reacted with the polymeric matrix to become an integral part thereof.

In one embodiment of the present invention, the agent(s) selected for the polyester masterbatch as a branching agent is preferably a polyol. (Anspruch 3)

The agent(s) selected for the masterbatch is preferably a coupling agent, and the coupling agent is preferably a dianhydride. It will be appreciated by those skilled in the art, that a dianhydride can also function as a branching agent. For convenience, an agent which can function as both a branching and a coupling agent may herein also be referred to as a “branching/coupling agent”. (Anspruch 4)

In a preferred embodiment of the present invention, the agents selected for the polyester masterbatch are a branching agent in conjunction with a coupling agent. In this case, the branching agent is preferably a polyol and the coupling agent is preferably a dianhydride.

It is an important feature of the present invention that the branching and/or chain coupling agent is dispersed in a polymeric matrix of a styrene containing homopolymer or copolymer. In particular, that the branching and/or chain coupling agent is melt mixed with the a styrene containing homopolymer or copolymer to become dispersed within the polymeric matrix of the a styrene containing homopolymer or copolymer.

A particular advantage provided by the masterbatch of the present invention is that it can be prepared using a diverse range of branching and/or chain coupling agents at both high and low concentrations without significant change in the rheological properties of the carrier styrene containing homopolymer or copolymer occurring. This advantage is particularly evident where a polyol branching agent is employed, or where low levels (from about 1 to about 5 weight percent) of a branching/chain coupling agent such as pyromelletic dianhydride are employed.

Preferably, the branching and/or chain coupling agent has a melt temperature which is at least 10° C. higher, more preferably at least 20° C. higher, still more preferably at least 40° C. higher than the melt processing temperature of the styrene containing homopolymer or copolymer.

Preferably, the branching and/or chain coupling agent is present as a separate phase in the molten styrene containing homopolymer or copolymer during melt mixing. In particular, it is preferred that at least 50 weight percent, more preferably at least 65 weight percent, most preferably at least 85 weight percent of the branching and/or chain coupling agent is present as a separate phase in the molten styrene containing homopolymer or copolymer during melt mixing. In a particularly preferred embodiment, substantially all of the branching and/or chain coupling agent is present as a separate phase in the molten styrene containing homopolymer or copolymer during melt mixing.

The masterbatch of the present invention provides a means of distributing the branching and/or chain coupling agent uniformly in a base polyester. In order to ensure branching and/or chain extension occurs uniformly in the base polyester during melt mixing, it is important that the masterbatch rapidly melts to thereby rapidly disperse the agent throughout the molten base polyester. It is believed that the agent can be more efficiently dispersed throughout the base polyester when the melt processing temperature of the masterbatch carrier, the styrene containing homopolymer or copolymer, is lower than that of the base polyester.

A common base polyester that may be modified using a masterbatch in accordance with the present invention is PET.

Preferably, a low melt processing temperature styrene containing homopolymer or copolymer suitable for use in the masterbatch will have a melt processing temperature ranging from 130° C. to 250° C., more preferably from about 160° C. to about 240° C., most preferably from about 180° C. to about 230° C.

As used herein, the term “copolymers” means that the polymer contains at least two monomers, which can be linked together statistically within the polymer backbone, grafted on the polymer backbone, or in blocks. The stereo structure of the polymer can be syndiotactic, isotactic, hemi-isotactic or atactic.

Typical styrene containing homopolymers and copolymers are for example: Polystyrene, Poly-(p-methylstyrene), Poly-(α-methylstyrene).

Aromatic homopolymers and copolymers containing vinylaromatic monomers for instance styrene, α-methylstyrene, all isomers of vinyltoluene, e.g. p-vinyltoluene, all isomers of ethyl-styrene, propyl-styrene, vinylbiphenyl, vinyinaphthaline, vinylanthracene and mixtures therof.

Copolymers include the above mentioned vinylaromatic monomers and comonomers selected from ethylene, propylene, dienes, nitrilen, acids, maleinic acid anhydrides, maleinic acid amides, vinylacetat, vinylchlorid und derivatives of acrylic acid and mixtures thereof, e.g. styrene-butadiene, styrene-acrylonitrile, styrene-ethylene (also interpolymers), styrene-alkylmethacrylates, styrene-butadien-alkylacrylates and -methacrylates, styrene-maleinic acid anhydride, styrene-acrylonitrile-methylacrylate; mixtures for increased impact strength from styrene-copolymers and other polymer, e.g. polyacrylates, diene-polymers or ethylene-propylene-diene-terpolymers; as well as block-copolymers of styrene, e.g. styrene-butadiene-styrene, styrene-isoprene-styrene, styrene-ethylene/butylene-styrene or styrene-ethylene/propylene-styrene.

Hydrogenated aromatic polymers prepared by hydration of polymers listed above, especially polycydohexylethylene (PCHE), also called polyvinylcyclohexane (PVCH), which is prepared by hydrogenation of atactic polystyrene.

Graft-copolymers of vinylaromatic monomers, e.g. styrene on polybutadiene, styrene on polybutadiene-co-styrene or polybutadiene-acrylonitrile-copolymers, styrene and acrylonitrile (or methacrylonitrile) on polybutadiene; styrene, acrylonitrile and methylmethacrylate on polybutadiene; styrene and maleinic acid anhydride on polybutadiene; styrene, acrylonitrile and maleinic acid anhydride or maleinic acid imide on polybutadiene; styrene and maleinic acid imide on polybutadiene, styrene and alkylacrylates or alkylmethacrylates on polybutadiene, styrene and acrylonitrile on ethylene-pmpylene-diene-terpolymers, styrene and acrylonitrile on polyalkylacrylates or polyalkylmethacrylates, styrene and acrylonitrile on acrylate-butadiene-copolymers, as well as mixtures thereof and mixtures with polymers listed above, e.g so-called ABS-, MBS-, ASA- or AES-polymers.

The masterbatch in accordance with the present invention may comprise a branching agent. Preferred branching agents include, but are not limited to, polyols and polyfunctional acid anhydrides.

Suitable polyol branching agents for use in the masterbatch have a functionality of three or more, which will be understood to mean that they have at least three hydroxy groups per molecule. For example, glycerol has a functionality of three and pentaerythritol has a functionality of four. Examples of suitable polyol branching agents, or precursors thereto, include, but are not limited to, trimethylolethane, pentaerythritol sorbitol, 1,1,4,4-tetrakis(hydroxymethyl)cyclohexane, and dipentaerythritol, tripentaerythritol etc. One or more polyol branching agent may be used in combination.

Preferred polyol branching agents, or derivatives thereof, include pentaerythritol, dipentaerythritol, tripentaerythritol, and trimethylolethane.

As indicated above, the polyol branching agent may be provided in the form of a precursor thereto, or derivative thereof. By “precursor thereto” or derivative thereof it is meant a compound that is converted to the polyol during preparation of the masterbatch by melt processing.

Where the masterbatch in accordance with the present invention comprises additionally a polyol branching agent, the polyol is preferably present in an amount from about 0.3 to about 30 weight percent, more preferably from about 0.3 to about 20 weight percent, most preferably from about 1 to about 10 weight percent, relative to the polyester carrier polymer. (Anspruch 5)

Suitable polyfunctional acid anhydrides for use in the masterbatch have a functionality of three or more, which will be understood to mean that the polyfunctional acid anhydrides have at least three acid groups or acid group residues per molecule. For example, trimellitic acid anhydride has a functionality of three and pyromellitic acid dianhydride has a functionality of four.

Examples of polyfunctional and anhydrides that can be used in the masterbatch of the present invention include aromatic acid anhydrides, cyclic aliphatic anhydrides, halogenated acid anhydrides, pyromellitic dianhydride, benzophenonetetracarboxylic acid dianhydride, cyclopentanetetracarboxylic dianhydride, diphenyl sulfone tetracarboxylic dianhydride, 5-(2,5-dioxotetrahydro-3-furanyl)-3-methyl-3-cyclohexene-1,2-dicarboxylic dianhydride, bis(3,4-dicarboxyphenyl)ether dianhydride, bis(3,4-dicarboxyphenyl)thioether dianhydride, bisphenol-A bisether dianhydride, 2,2-bis(3,4-dicarboxyphenyl)hexafluoropropane dianhydride, 2,3,6,7-napthalenetetracarboxylic acid dianhydride, bis(3,4-dicarboxyphenyl)sulfone dianhydride, 1,2,5,6-napthalenetetracarboxylic acid dianhydride, 2,2′,3,3′-biphenyltetracarboxylic acid, hydroquinone bisether dianhydride, 3,4,9,10-perylene tetracarboxylic acid dianhydride, 1,2,3,4-cyclobutanetetracarboxylic acid dianhydride, 3,4-dicarboxy-1,2,3,4-tetrahydro-1-naphthalene-succinic acid dianhydride, bicyclo(2,2)oct-7-ene-2,3,5,6-tetracarboxylic acid dianhydride, tetrahydrofuran-2,3,4,5-tetracarboxylic acid dianhydride, 2,2-bis(3,4-dicarboxyphenyl)propane dianhydride, 3,3′,4,4′-biphenyltetracarboxylic acid dianhydride, 4,4′-oxydiphthalic dianhydride (ODPA), and ethylenediamine tetraacetic acid dianhydride (EDTAh). It is also possible to use acid anhydride containing polymers or copolymers as the anhydride component. Two or more polyfunctional acid anhydrides may be used in combination.

Preferred polyfunctional acid anhydrides, include pyromellitic dianhydride, 1,2,3,4-cyclopentanetetracarboxylic acid dianhydride, 1,2,3,4-cyclobutanetetracarboxylic acid dianhydride and tetrahydrofuran-2,3,4,5-tetracarboxylic acid dianhydride. Most preferably the polyfunctional acid anhydride is pyromellitic dianhydride.

As indicated above, the polyfunctional acid anhydride may contain acid groups or acid group residues. By “acid group residue” is meant a residue of a carboxylic acid that has condensed with a second carboxylic acid to form an anhydride. In this case, the anhydride formed would contain two acid group residues.

Where the masterbatch in accordance with the present invention comprises a branching agent other than a polyol branching agent, the branching agent is preferably present in an amount from about 1 to about 60 weight percent, more preferably from about 5 to about 40 weight percent, most preferably from about 5 to about 30 weight percent, relative to the polyester carrier polymer.

The masterbatch in accordance with the present invention may comprise a chain coupling agent. Chain coupling agents that may be used with the present invention indude, but are not limited to, polyfunctional acid anhydrides, epoxy compounds, oxazoline derivatives, oxazolinone derivatives, lactams and related species. For examples of additional chain coupling agents we refer to Inata and Matsumura, J. App. Pol. Sci., 303325 (1988) and Lootjens et al J. App. Pol. Sci 65 1813 (1997) and Brown in “Reactive Extrusion” Ed Xanthos, Hanger, New York 1992 p 75.

Those containing anhydride or lactam units are preferred for reaction with alcohol functionality of a base polyester when the masterbatch is subsequently used. Those containing oxazoline, oxazolinone, epoxide, carbodiimide units are preferred for reaction with acid functionality of a base polyester when the masterbatch is subsequently used.

Preferred chain coupling agents which may be used alone or in combination include the following:

(1) Polyepoxides such as bisphenole-A-diglycidylether, ebis(3,4-epoxycycohexylmethyl) adipate; N,N-diglycidyl bemzamide (and related diepoxies); N,N-diglycidyl aniline and derivatives; N,N-diglycidylhydantoin, uracil, barbituric acid or isocyanuric acid derivatives; N,N-diglycidyl diimides; N,N-diglycidyl imidazolones; epoxy novolaks; phenyl glycidyl ether; diethyleneglycol diglycidyl ether; Epikote 815 (diglycidyl ether of bisphenol A-epichlorohydrin oligomer).

(2) Polyoxazolines/Polyoxazolones such as 2,2-bis(2-oxazoline); 1,3-phenylene bis (2-oxazoline-2), 1,2-bis(2-oxazolinyl-2)ethane; 2-phenyl-1,3-oxazoline; 2,2′-bis(5,6-dihydro-4H-1,3-oxazoline); N,N′-hexamethylenebis (carbamoyl-2-oxazoline; bis[5(4H)-oxazolone); bis(4H-3,1benzoxazin-4-one); 2,2′-bis(H-3,1-benzozin-4-one);

(3) Polyisocyanates such as 4,4′-methylenebis(phenyl isocyanate) (MDI); toluene diisocyanate, isocyanate terminated polyurethanes; isocyanate terminated polymers;

(4) Anhydrides

Examples of polyfunctional acid anhydrides are as previously defined for the branching agents.

(5) Polyacyllactams such as N,N′-terephthaloylbis(caprolactam) and N,N′-terephthaloylbis-(laurolactam). The use of these and similar compounds for PET chain extension has been disclosed by Akkapeddi and Gervasi in U.S. Pat. No. 4,857,603.

(6) Phosphorous (III) coupling agents such as triphenyl phosphite (Jaques et al Polymer 38 5367 (1997)) and other compounds such as those disclosed by Aharoni in U.S. Pat. No. 5,326,830.

Where the masterbatch in accordance with the present invention comprises a chain coupling agent, the chain coupling agent is preferably present in an amount of from about 1 to about 60 weight percent, more preferably from about 5 to about 40 weight percent, more preferably from about 5 to about 30 weight percent, relative to the polyester carrier. (Anspruch 6)

In a further embodiment of the invention the masterbatch composition may comprise additionally a phosphite, a phosphinate or a phosphonate compound. (Anspruch 7)

Phosphonates are in general preferred.

Preferably the phosphonate is of formula II 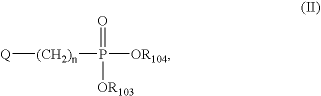
wherein

R₁₀₃ is H, C₁-C₂₀alkyl, unsubstituted or C₁-C₄alkyl-substituted phenyl or naphthyl,

R₁₀₄ is hydrogen, C₁-C₂₀alkyl, unsubstituted or C₁-C₄alkyl-substituted phenyl or naphthyl; or

M^{r+}/r,

M^{r+} is an r-valent metal cation or the ammonium ion,

n is 0, 1, 2, 3, 4, 5 or 6, and

r is 1, 2, 3 or 4;

Q is hydrogen, —X—C(O)—OR₁₀₇, or a radical

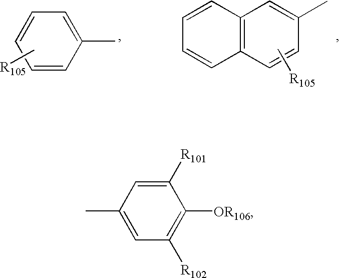

R₁₀₁ is isopropyl, tert-butyl, cydohexyl, or cyclohexyl which is substituted by 1-3 C₁-C₄alkyl groups,

R₁₀₂ is hydrogen, C₁-C₄alkyl, cyclohexyl, or cyclohexyl which is substituted by 1-3 C₁-C₄alkyl groups,

R₁₀₅ is H, C₁-C₁₈alkyl, OH, halogen or C₃-C₇cycloalkyl;

R₁₀₆ is H, methyl, trimethylsilyl, benzyl, phenyl, sulfonyl or C₁-C₁₈alkyl;

R₁₀₇ is H, C₁-C₁₀alkyl or C₃-C₇cycloalkyl; and

X is phenylene, C₁-C₄alkyl group-substituted phenylene or cyclohexylene.

Other suitable phosphonates are listed below.

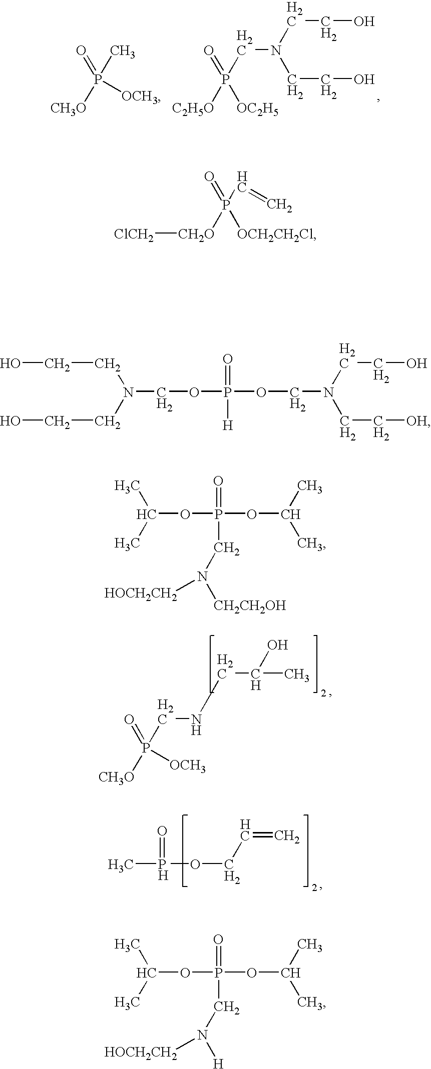

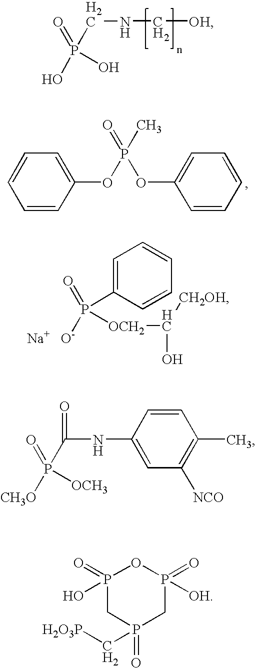

Sterically hindered hydroxyphenylalkylphosphonic acid esters or half-esters, such as those known from U.S. Pat. No. 4,778,840, are preferred.

Halogen is fluoro, chloro, bromo or iodo.

Alkyl substituents containing up to 18 carbon atoms are suitably radicals such as methyl, ethyl, propyl, butyl, pentyl, hexyl and octyl, stearyl and also corresponding branched isomers; C₂-C₄alkyl and isooctyl are preferred.

C₁-C₄Alkyl-substituted phenyl or naphthyl which preferably contain 1 to 3, more preferably 1 or 2, alkyl groups is e.g. o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl, 2,6-diethylphenyl, 1-methyinaphthyl, 2-methyl-naphthyl, 4-methylnaphthyl, 1,6-dimethylnaphthyl or 4-tert-butylnaphthyl.

C₁-C₄Alkyl-substituted cyclohexyl which preferably contains 1 to 3, more preferably 1 or 2, branched or unbranched alkyl group radicals, is e.g. cyclopentyl, methylcydopentyl, dimethylcyclopentyl, cyclohexyl, methylcydohexyl, dimethylcyclohexyl, trimethylcyclohexyl or tert-butylcyclohexyl.

A mono-, di-, tri- or tetra-valent metal cation is preferably an alkali metal, alkaline earth metal, heavy metal or aluminium cation, for example Na⁺, K⁺, Mg⁺⁺, Ca⁺⁺, Ba⁺⁺, Zn⁺⁺, Al⁺⁺⁺, or Ti⁺⁺⁺⁺, Ca⁺⁺ is particularly preferred.

Preferred compounds of formula I are those containing at least one tert-butyl group as R₁ or R₂. Very particularly preferred compounds are those, wherein R₁ and R₂ are at the same time tert-butyl.

n is preferably 1 or 2 and, in particular 1.

For example the phosphonate is of formula IIa 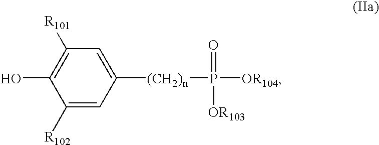
wherein

R₁₀₁ is H, isopropyl, tert-butyl, cyclohexyl, or cyclohexyl which is substituted by 1-3 C₁-C₄alkyl groups,

R₁₀₂ is hydrogen, C₁-C₄alkyl, cyclohexyl, or cyclohexyl which is substituted by 1-3 C₁-C₄alkyl groups,

R₁₀₃ is C₁-C₂₀alkyl, unsubstituted or C₁-C₄alkyl-substituted phenyl or naphthyl,

R₁₀₄ is hydrogen, C₁-C₂₀alkyl, unsubstituted or C₁-C₄alkyl-substituted phenyl or naphthyl; or

M^{r+}/r;

M^{r+} is an r-valent metal cation, r is 1, 2, 3 or 4; and

n is 1, 2, 3, 4, 5 or 6.

Preferably the phosphonate is of formula III, IV, V, VI or VII 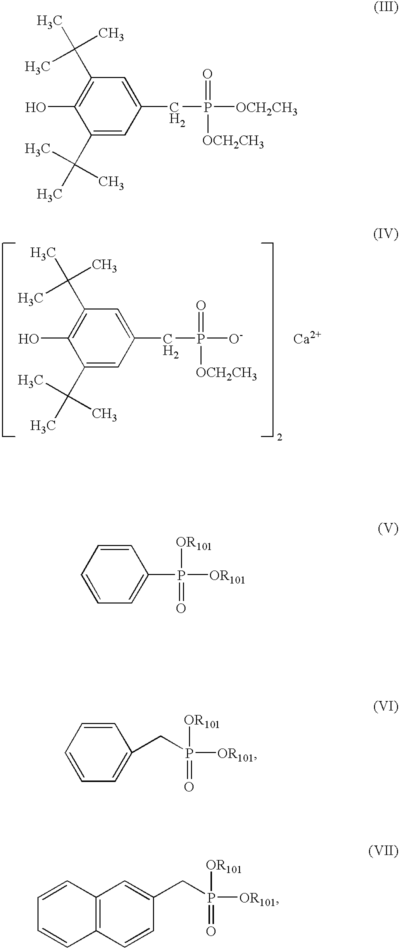
wherein the R₁₀₁ are each independently of one another hydrogen or M^{r+}/r. (Anspruch 8)

Some of the compounds of formulae II, IIa, III, IV, V, VI, VII and VIII are commercially available or can be prepared by standard processes, as for example described in U.S. Pat. No. 4,778,840.

The phosphinates are of the formula XX 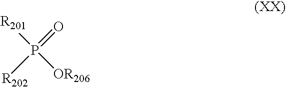
wherein
R₂₀₁ is hydrogen, C₁-C₂₀alkyl, phenyl or C₁-C₄alkyl substituted phenyl; biphenyl, naphthyl, —CH₂—O—C₁-C₂₀alkyl or —CH₂—S—C₁-C₂₀alkyl,
R₂₀₂ is C₁-C₂₀alkyl, phenyl or C₁-C₄alkyl substituted phenyl; biphenyl, naphthyl, —CH₂—O—C₁-C₂₀alkyl or —CH₂—S—C₁-C₂₀alkyl, or R₁ and R₂ together are a radical of the formula XXI 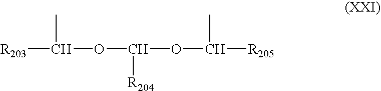
wherein
R₂₀₃, R₂₀₄ and R₂₀₅ independently of each other are C₁-C₂₀alkyl, phenyl or C₁-C₄alkyl substituted phenyl;
R₂₀₆ is hydrogen, C₁-C₁₈alkyl or a the ion of an alkali metal or the ammonium ion or R₂₀₆ is a direct bond, which forms together with R₂₀₂ an aliphatic or aromatic cyclic ester.

The alkali metal is for example Na or K.

A specific phosphinate is for example compound 101

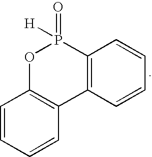

Further specific examples of phosphinates are given in EP 0 896 023 and DE 198 863, which are incorporated by reference.

Typical phosphites useful in the instant invention are for example listed below.

For example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)penta-erythritol diphosphite, tristearyl sorbitol triphosphite, 6-isooctyloxy-2,4,8,10-tetra-tert-butyl-12H-dibenz[d,g]-1,3,2-dioxaphosphocin, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

Especially preferred are the following phosphites:

Tris(2,4-di-tert-butylphenyl) phosphite (Irgafos®168, Ciba Specialty Chemicals), tris(nonyl-phenyl) phosphite,

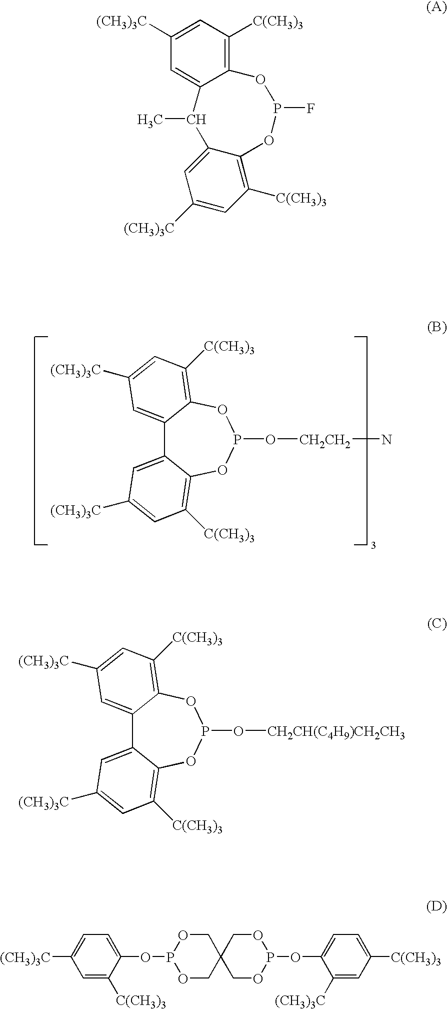

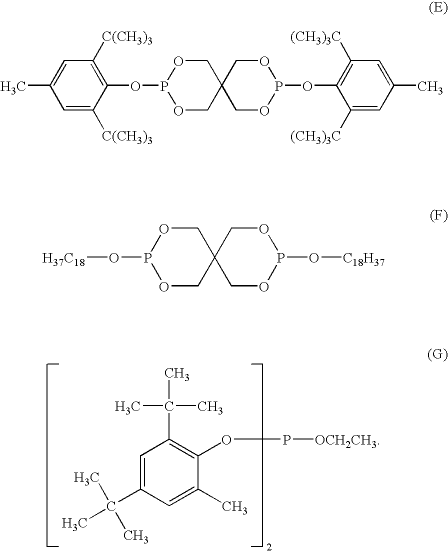

The masterbatch of the present invention is prepared by melt mixing a styrene containing homopolymer or copolymer with a branching and/or chain coupling agent. Melt mixing can be performed using methods well known in the art. Preferably, melt mixing is achieved by continuous extrusion equipment such as twin screw extruders, single screw extruders, other multiple screw extruders, such as Buss kneaders and Farell mixers. Preferably, melt mixing is performed so as to maintain the polyester at its melt processing temperature.

In preparing the masterbatch, one or more styrene containing homopolymers or copolymers and one or more branching and/or chain coupling agents may be used.

Consequently in another aspect, the present invention provides a method of preparing a masterbatch comprising melt mixing a styrene containing homopolymer or copolymer with a branching and/or chain coupling agent such that the branching and/or chain coupling agent is dispersed within the polymeric matrix of the styrene containing homopolymer or copolymer. (Anspruch 10)

The definitions and preferences given above for the composition also apply for the process of manufacturing a masterbatch.

The process of preparing the masterbatch can be performed in one or more processing steps.

Moreover, all the ingredients of the masterbatch can be mixed before and metered into an extruder, or metered separately.

Another option is the extrusion of one part of the masterbatch, and adding the other parts of the masterbatch later in the process. For example, the carrier polymer is metered into the extruder right from the beginning, and the active ingredients are metered in higher extrusion zones.

The masterbatches of the present invention may be used to modify a base polyester by melt mixing the base polyester with the masterbatch. A single masterbatch or a combination of masterbatches may be used. By this method, the polyester is modified through reaction with the branching agent to introduce branching within, or chain extend, the polyester chain structure. Typically, the base polyester will have a higher melt processing temperature than the masterbatch carrier polymer.

If desired, the modified polyester can be subjected to further processing, such as a solid state condensation process, to increase its molecular weight. Alternatively, where a chain coupling agent has not been used, the modified polyester may be subsequently melt mixed with a chain coupling agent to increase its molecular weight. Preferably, the base polyester is melt mixed with a masterbatch comprising a chain coupling agent.

High melt strength polyesters may be obtained by melt mixing a base polyester with a polyol branching agent and a polyfunctional acid anhydride. In one preferred embodiment of the present invention a base polyester is modified using a combination of masterbatches prepared in accordance with the present invention comprising a polyol branching agent and a polyfunctional acid anhydride, respectively.

In another preferred embodiment of the invention, the masterbatch comprises a combination of a polyol branching agent and a polyfunctional acid anhydride. By combining these two agents in the masterbatch, the need for two separate masterbatches is conveniently avoided. Accordingly, such a masterbatch advantageously comprises both a polyol branching agent and a polyfunctional acid anhydride dispersed within a polymeric matrix of a styrene containing homopolymer or copolymer.

Other chain coupling agents may also be combined with a polyol branching agent in a masterbatch according to the present invention.

Where a masterbatch comprising a combination of branching and/or chain coupling agents is prepared, it may be that the branching and/or chain coupling agents react with each other to some extent during melt mixing. In this case, the resulting reaction product(s) may also be a branching and/or chain coupling agent(s) in its own right and therefore be a suitable agent(s) to act as a branching and/or chain coupling agent in accordance with the present invention.

In a further aspect, the present invention provides a method for modifying a polyester comprising melt mixing the polyester at a temperature above 250° C. together with the styrene containing homopolymer or copolymer masterbatch as described above. (Anspruch 11)

Polyesters that can be modified by the method of the present invention are preferably thermoplastic polyesters and include all heterochain macromolecular compounds that possess repeat carboxylate ester groups in the backbone of the polymer. Also suitable for use as polyesters are polymers which contain esters on side chains or grafts, copolymers which incorporate monomers having carboxylate ester groups (in the backbone or as side groups or grafts) and derivatives of polyesters which retain the carboxylate ester groups (in the backbone or side groups or grafts). The polyesters may also contain acids, anhydrides and alcohols in the backbone or as side chains (eg acrylic and methacrylic containing polymers). Preferred polyesters include poly(ethylene terephthalate) (PET), poly(butylene terephthalate) (PBT), poly(ethylene naphthalate) (PEN), poly(tri-methylene terephthalate) (PTT), copolymers of PET, copolymers of PBT, copolymers of PEN, liquid crystalline polyesters (LCP) and polyesters of carbonic acid (polycarbonates) and blends of one or more thereof.

Copolymers of PET include variants containing other comonomers. For example, the ethane diol may be replaced with other diols such as cydohexane dimethanol to form a PET copolymer. Copolymers of PBT include variants containing other comonomers. Copolymers of PEN include variants containing other comonomers. Copolymers of PEN/PET are also useful in the present invention. These copolymers may be blended with other polyesters.

Liquid crystalline polyesters include poly(hydroxybenzoic acid) (HBA), poly(2-hydroxy-6-naphthoic acid) and poly(naphthalene terephthalate) (PNT) which is a copolymer of 2,6-dihydroxynaphthalene and terephthalic acid. Copolymers of liquid crystal polyesters with other polyesters are also suitable.

Side chain or graft ester, acid or alcohol containing polymers include: poly(methyl methacrylate) (or other methacrylates or acrylates); poly(methacrylic acid); poly(acrylic acid); poly(hydroxyethyl methacrylate), starch, cellulose etc.

Copolymers or graft copolymers containing acid, ester or alcohol groups indude ethylene co-vinyl acetate, ethylene co-vinyl alcohol, ethylene co-acrylic acid, maleic anhydride grafted polyethylene, polypropylene etc.

Where the masterbatch of the present invention comprises a polyol branching agent and a polyfunctional acid anhydride, it is preferred that the molar ratio of the polyfunctional acid anhydride to the polyol branching agent, or precursor thereto, is in the range of 0.5:1 to (10×C):1, where C is the number of moles of hydroxy groups per mole of polyol branching agent. It is particularly preferred that the molar ratio of polyfunctional acid anhydride to polyol, or precursor thereto, is in the range of from 2:1 to (2×C):1.

In order to clearly demonstrate the calculation of the molar ratio the following example is provided:

Example Calculation: Masterbatch composition comprising pyromellitic dianhydride (PMDA) and pentaerythritol.

| | |
|---|---|
| PMDA = | tetra functional anhydride |
| Pentaerythritol = | tetra functional alcohol |

The polyol, pentaerythritol, used in this example has a functionality of 4, therefore C=4.

The mole ratio of PMDA to pentaerythritol is therefore in the range of from 0.2:1 to 40 (10×4):1, with the preferred mole ratio of PMDA to pentaerythritol being in the range of from 2:1 to 8 (2×4):1. Accordingly, a masterbatch comprising 2.5 weight percent of pentaerythritol would comprise PMDA preferably in an amount ranging from about 8 weight percent to about 32 weight percent (ie in a mole ratio ranging from 2:1 to 8:1).

Where the masterbatch of the present invention only comprises one of a polyfunctional acid anhydride or a polyol branching agent, but the masterbatch is used to modify a base polyester where both a polyol and an anhydride are used, the molar ratio of polyol branching agent and polyfunctional acid anhydride is also preferably as previously defined.

The masterbatch in accordance with the present invention may comprise other additives such as fillers, pigments, stabilizers, blowing agents, nucleating agents etc. For examples of these and other suitable additional additives see U.S. Pat. No. 6,469,078.

The masterbatch may also comprise additives, such as heat stabilizers, light stabilizers, processing stabilizers, metal deactivators, nucleating agents and optical brighteners. Examples are given below.

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicydopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra(5-tert-butyl-4-hydroxy-2-methylphenyl)pentane.

1.7. O—, N— and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicydohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol-propane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3.5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cydohexyl-N′-phenyl-p-phenylenediamine, 4-(p-toluenesulfamoyl)diphenylamine, N,N′-dimethyl-N,N′-disec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyidiphenylamines, a mixture of mono- and dialkylated dodecyidiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetra-methylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyl-oxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂ [symbol] ₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]-benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetra-methyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyl-oxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-tri-chloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4ctyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl-phenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

5. Nitrones, for example N-benzyl-alpha-phenylnitrone, N-ethyl-alpha-methyinitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxyl-amine derived from hydrogenated tallow amine.

6. Thiosynergists, for example dilauryl thiodipropionate or distearyl thiodipropionate.

7. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

8. Polyamide stabilisers, for example copper salts in combination with iodides and/or phosphorus compounds and salts of divalent manganese.

9. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

10. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyidibenzylidene)sorbitol, and 1,3:2,4-di(benzylidene)sorbitol.

11. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

12. Other additives, for example plasticisers, lubricants, emulsifiers, pigments, rheology additives, catalysts, flow-control agents, optical brighteners, flameproofing agents, antistatic agents and blowing agents.

13. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A4316611; DE-A-4316622; DE-A-4316876; EP-A-0589839 or EP-A-0591102 or 3-[4-(2-acetoxyethoxy)-phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzo-furan-2-one, 3-(3,4-dimethylphenyl)-5,7-di-tert-butylbenzofuran-2-one, 3-(2,3-dimethylphenyl)-5,7-di-tert-butylbenzofuran-2-one.

In a method of the present invention, a base polyester is modified by melt mixing the polyester with the masterbatch of the present invention. Condensation or transesterification catalysts may also be added to the melt mixing process in order to enhance the reaction rate of the polyol branching agent, and if present chain coupling agent, with the base polyester.

In a specific embodiment the masterbatch composition also indudes a condensation or transesterification catalyst. (Anspruch 9)

Typical transesterification or condensation catalysts include, but are not limited to, Lewis acids such as antimony trioxide, titanium oxide and dibutyltin dilaurate.

Other additives which may be incorporated with the masterbatch during melt mixing to modify the polyester include monofunctional additives to act as blockers so as to control the degree of chain extension and/or branching, as described by Edelman et al. in U.S. Pat. No. 4,1611,579, for the production of controlled branched polyesters by a combination of condensation/solid state polycondensation. Examples of suitable monofunctional additives include acids (eg. benzoic acid) or anhydrides or esters thereof (eg. benzoic acid anhydride, acetic anhydride). Monofunctional alcohols may also be used.

Additives (eg. carbonates) may be incorporated to enhance foaming of the modified polyester where foamed products are required. Gases may also be injected into the molten polyester during melt mixing in order to achieve physical rather than chemical foaming.

In a method of the present invention a base polyester is modified by melt mixing it with the masterbatch of the present invention. Melt mixing may conveniently be achieved by continuous extrusion equipment such as twin screw extruders, single screw extruders, other multiple screw extruders and Farell mixers. Semi-continuous or batch polymer processing equipment may also be used to achieve melt mixing. Suitable equipment indudes injection moulders, Banbury mixers and batch mixers. Static mixing equipment may include pipes containing fixed obstacles arranged in such a way as to favour the subdivision and recombination of the flow to thoroughly mix the masterbatch, and any other additives or agents used, with the polyester.

The molecular structure of a modified polyester formed by the method of the present invention may exhibit a degree of branching. As discussed above, it may also be necessary to increase the molecular weight of the modified polyester to effect an increase in the polymers melt strength and melt viscosity. This can conveniently be achieved in a number of ways, for example the modified polyester may be subjected to a solid state condensation process, or a chain coupling agent may be used in the modification process itself.

Modified polyesters that exhibit improved melt strength may be advantageously used in blown film applications where higher melt viscosity, viscoelasticity and strength in the melt allow higher blow up ratios, greater biaxial orientation and faster through-puts while maintaining bubble stability.

The increased melt strength can be easily detected by an increase of the diameter of the polyester strand at the die of the extruder (i.e. die swell), compared to unmodified polyester. Further apparatus/parameters for characterizing the melt strength are: Goettfert Rheotens, uniaxial elongational viscosity and dynamic rheology.

The improved melt rheology of such modified polyester advantageously allows the reduction in processing steps and improvement in material properties. The improvements in melt rheology can allow the modified polyesters to be processed without prior drying, and facilitate the blow molding of polyesters. In particular, the improvements in the melt rheology facilitate stretch blow molding, facilitate the foaming of polyesters, enhance adhesion of the polyester to polar fillers such as those used in glass reinforced polyesters, and permit polyesters to be thermoformed with greater ease.

The use of the masterbatch composition according to the invention is beneficial within several plastic applications, for instance:
Beverage or cosmetic articles bottles
Film packaging for food or non-food
Sheets (e.g. thermoformable) for packaging (trays), construction or automotive applications
Injection molded articles
Belts or strappings
Profiles or pipes
Drums
Bottle crates
Textiles and non-wovens

The benefits caused by the instant masterbatch compositions are for example based on following effects:
Higher productivity according to adjusted melt rheology of the polyester (simpler processing)
Reaching technical feasibility of performing extrusion blow molding or extrusion blowing films with modified polyesters
Increasing molecular weight or/and melt strength without discoloration or gel formation
Increasing long-term thermal stability by initially higher molecular weight
Increasing mechanical properties (e.g. better tensile strength, higher elongation at break, higher burst pressure of bottles)
Improved impact properties (e.g. impact strength at ambient and temperature of −40° C., which is for example important for achieving better drop test result of frozen food articles in a tray)
Enhanced gas barrier (e.g. O₂, CO₂) by higher molecular weight and modified polymer chain structure
Superior thermal dimensional stability by higher molecular weight and modified polymer chain structure
processing polyester without pre-drying
compensating loss of molecular weight (I.V. loss) during melt processing
up-grading lower value PET grades during processing
recycling of degraded PET (post consumer or production waste)
pultrusion of PET-fibers
matching processing properties of C-PET (crystallizable)
replacing e.g. polycarbonate by modified polyesters

The masterbatches of the present invention may be preferably used in the following applications. Modification of bottle grade (IV ˜0.80) or recycle PET to produce a polyester suitable for thermoforming. Modification of recycle PET to produce a polyester suitable for reforming into bottles. Modification of bottle or recycle PET to produce a polyester suitable for extrusion blow molding. Modification of bottle or recycle PET to produce a polyester suitable for foaming.

Consequently a further aspect of the invention is the use of a masterbatch composition as described above for the modification of polyesters. (Anspruch 12)

The present invention is further described with reference to the following non-limiting examples.

### EXAMPLES

Materials and Analytical Procedures

Intrinsic Viscosity (I.V.):

1 g polymer is dissolved in 100 g of a mixture of phenol/di-chloro-benzene (1/1). The viscosity of this solution is measured at 30° C. in an Ubelode-viscosimeter and recalculated to the intrinsic viscosity.

Melt Flow Ratio (MFR):

MFR is determined within Goettfert MP-P according to ISO 1133.

Materials:

Carrier polymer, Polystyrene 165H from BASF.

Chain coupling agent, pyromellitic acid dianhydride (PMDA) from Beyo (China) (powder, melt temperature: 284° C.).

Branching agent, pentaerythritol (PENTA) from Perstorp (Finnland, melt temperature: 262° C.)

Additives

Irgamod 195, which is a phosphonate, from Ciba Specialty Chemicals.

Base polyester (to be modified by the masterbatch).

All base polyesters are dried prior to use (>12 h at 80° C. in vacuo)

PET: ICI LaserPlus from ICI

A) Production of a Masterbatch

General Procedure:

In a twin screw extruder (ZSK 25 from Werner & Pfleiderer) with screws rotating in the same direction, the formulations given in Table 1 are extruded at a temperature of Tₘₐₓ=220° C. (heating zone 1-6), a throughput of 5 kg/h at 100 rev/min and pelletized in a water bath.

### Examples 1 to 3

TABLE 1

| | Masterbatch, | | | |
|---|---|---|---|---|
| | polystyrene as | Chain coupling/ | | |
| Ex. No. | carrier polymer | branching agent | | Further additive(s) |
| Ex. A1 | 75% C | 25% | PMDA | — |
| Ex. A2 | 72.5% C | 25% | PMDA | — |
| | | 2.5% | PENTA | |
| Ex. A3 | 70% C | 25% | PMDA | 2.5% Irgamod 195 |
| | | 2.5% | PENTA | |

B) Modification of a Base Polymer using the Masterbatches

General Procedure

In a twin screw extruder (ZSK 25 from Werner & Pfleiderer) with screws rotating in the same direction, the formulations given in Table 2 are extruded at a temperature of Tₘₐₓ=280° C. (heating zone 1-6), a throughput of 6 kg/h, 100 rev/min and pelletized in a water bath.

TABLE 2

| | | |
|---|---|---|
| Ex. No. | Formulation | I.V. [dl/g] |

| | | | |
|---|---|---|---|
| Ex B1 | 100% | PET | 0.81 |
| | 0.4% | Ex A1 | |
| Ex B2 | 100% | PET | 0.89 |
| | 1% | Ex A1 | |
| Ex B3 | 100% | PET | 0.80 |
| | 0.4% | Ex 2 | |
| Ex B4 | 100% | PET | 0.83 |
| | 1% | Ex A2 | |
| Ex B5 | 100% | PET | 0.79 |
| | 0.4% | Ex A3 | |
| Ex 6 | 100% | PET | 0.84 |
| | 1% | Ex 3 | |

Extrusion strands of examples 4 to 9 were all completely transparent, indicating the high compatibility of the masterbatch polymer.

1. A masterbatch composition for the modification of polyesters or copolyesters comprising
a chain coupling agent capable of reacting with the polyester or copolyester, which is dispersed within a polymeric matrix of a styrene containing homopolymer or copolymer.

2. A masterbatch composition according to claim 1 comprising additionally a chain branching agent.

3. A masterbatch composition according to claim 2 wherein the chain branching agent is a polyol.

4. A masterbatch composition according to claim 1 wherein the chain coupling agent is a dianhydride.

5. A masterbatch composition according to claim 2 wherein the branching agent is a polyol, which is present in an amount of from 0.3 to 30 weight percent based on the weight of the polymeric matrix.

6. A masterbatch composition according to claim 1 wherein the chain coupling agent is present in an amount of from 1 to 60 weight percent based on the weight of the polymeric matrix.

7. A masterbatch composition according to claim 1, which additionally comprises a phosphite, a phosphinate or a phosphonate compound.

8. A masterbatch composition according to claim 7 wherein the phosphonate is of formula lIl, IV, V, VI or VII 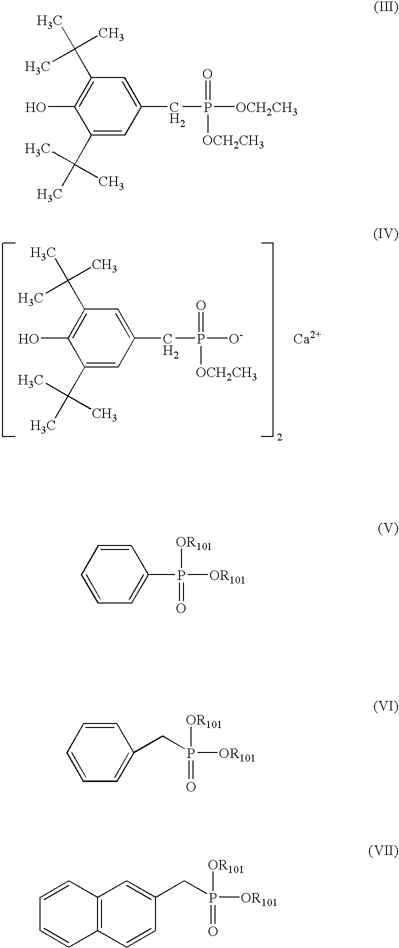
wherein
R₁₀₁ are each independently of one another hydrogen or M^{r+}/r,
M^{r+} is an r-valent metal cation or an ammonium ion and
r is 1, 2, 3 or 4.

9. A masterbatch composition according to claim 1, which also includes a condensation or transesterification catalyst.

10. A method of preparing a masterbatch comprising
melt mixing a styrene containing homopolymer or copolymer with a chain coupling agent such that the chain coupling agent is dispersed within the polymeric matrix of the styrene containing homopolymer or copolymer.

11. A method of modifying a polyester comprising
melt mixing a polyester at a temperature above 250° C. together with a masterbatch according to claim 1.

12. (canceled)

13. A method of modifying a polyester comprising
melt mixing a polyester at a temperature above 250° C. together with a masterbatch according to claim 2.
